(19) United States
(12) Patent Application Publication
(10) Pub. No.: US 2006/0007485 A1
(43) Pub. Date: Jan. 12, 2006

(54) Image pickup apparatus

(75) Inventor: Takao Miyazaki, Asaka-shi (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/175,344

(22) Filed: Jul. 7, 2005

(30) Foreign Application Priority Data
Jul. 8, 2004 (JP) 2004-202326

(51) Int. Cl. G06F 15/00

(52) U.S. Cl. 358/1.15

(57) ABSTRACT

The present invention provides an image pickup apparatus which obtains image data from an image pickup device at a capture directive, performs predetermined signal processing on the image data, and records the image data on a storage medium, comprising a communication device which communicates data with external equipment, a time count device which counts elapsed time from last capture and a communication control device which transmits the image data through the communication device to the external equipment when the elapsed time counted by the time count device exceeds predetermined time.

### BACKGROUND OF THE INVENTION

1. Field of the Invention

The present invention relates to an image pickup apparatus, and more specifically to an image pickup apparatus having the function of transmitting captured image data to external equipment.

2. Related Art

When an image captured by a digital camera is printed, normally an image taken by the digital camera is fetched by a personal computer, the personal computer sets a print size, the number of prints, etc., and outputs the settings to a printer.

On the other hand, Japanese Patent Application Laid Open No. 11-275501 describes a system of printing an image without a personal computer by transmitting image data captured by a child camera to a parent camera, generating necessary data for printing by the parent camera, and outputting the data directly to a printer.

### SUMMARY OF THE INVENTION

However, since the print system described in Japanese Patent Application Laid Open No. 11-275501 fetches image data of a child camera to a parent camera at a fetch directive from a camera operator, it takes time and trouble in fetching image data.

Additionally, since image data has to be manually deleted, it is necessary to always check the free space of a storage medium when taking images. Furthermore, it is also possible that images are mistakenly deleted before they can be completely transmitted.

Furthermore, since all print settings are performed on the parent camera, the child camera which actually captures images cannot set anything, thereby failing in quickly reflecting the intention of a camera operator in prints.

The present invention has been developed to solve the above-mentioned problems with the conventional technology, and aims at providing the image pickup apparatus capable of smoothly performing the operations from capturing image data and fetching the data to external equipment to issuing a print directive.

To attain the above-mentioned objective, the first aspect of the present invention provides an image pickup apparatus which obtains image data from an image pickup device at a capture directive, performs predetermined signal processing on the data, and records the data on a storage medium. The apparatus includes: a communication device which communicates data with external equipment; a time count device which counts elapsed time from last capture; and a communication control device which transmits the image data through the communication device to the external equipment when the elapsed time counted by the time count device exceeds predetermined time.

According to the present invention, when predetermined time passes after the last capture, the image data recorded on a storage medium is automatically transmitted to external equipment. Thus, the image data can be fetched without a troublesome transmitting operation. Furthermore, since image data is transmitted when a capturing process is not performed, the image data can be efficiently transmitted.

To attain the above-mentioned objective, the second aspect of the present invention provides an image pickup apparatus which obtains image data from an image pickup device at a capture directive, performs predetermined signal processing on the data, and records the data on a storage medium. The apparatus includes: a communication device which communicates data with external equipment; a contact detection device which detects contact of a finger with a release button directing capture; a time count device which counts elapsed time from last detection of the contact detection device; and a communication control device which transmits the image data through the communication device to the external equipment when the elapsed time counted by the time count device exceeds predetermined time.

According to the present invention, the image data recorded on a storage medium is automatically transmitted to external equipment when predetermined time passes after a release button is last touched. Thus, the image data can be fetched without a troublesome transmitting operation. Furthermore, since image data is transmitted when a capturing process is not performed, the image data can be efficiently transmitted.

To attain the above-mentioned objective, the third aspect of the present invention provides an image pickup apparatus based on the first or second aspect of the present invention. The apparatus further includes: an image analysis device which analyzes image data, and detects the number of persons taken in a captured image; a number-of-prints setting device which sets the number of persons detected by the image analysis device to the number of prints. With the configuration, information about the number of prints set by the number-of-prints setting device is added and the resultant image data is transmitted to external equipment.

According to the present invention, the number of persons taken in a captured image is automatically detected and set as the number of prints. Then, the information about the set number of prints is added and the resultant image is transmitted to external equipment. Thus, a troublesome operation of setting the number of prints on the external equipment can be omitted, and the print settings can be quickly performed.

To attain the above-mentioned objective, the fourth aspect of the present invention provides an apparatus based on the third aspect of the present invention. The apparatus further includes: a display device which displays the number of persons detected by the image analysis device; an amendment device which amends the number displayed on the display device. With the configuration, the number-of-prints setting device sets the number amended by the amendment device to the number of prints.

According to the present invention, the number of persons automatically detected by the image analysis device can be amended. Thus, the number of prints can be easily amended as necessary.

To attain the above-mentioned objective, the fifth aspect of the present invention provides an image pickup apparatus based on the first to fourth aspects of the present invention. The apparatus further includes a print size setting device which sets a print size of image data. With the configuration, information about a print size set by the print size setting device is added and the resultant image data is transmitted to external equipment.

According to the present invention, a print size of image data can be set. The information about the set print size is added, and the resultant image data can be transmitted to external equipment. Thus, a troublesome operation of setting a print size on the external equipment can be omitted, and the print settings can be quickly performed.

To attain the above-mentioned objective, the sixth aspect of the present invention provides an image pickup apparatus based on the first to fifth aspects of the present invention. The apparatus further includes a development condition setting device which sets a development condition of RAW image data. With the configuration, the information about a development condition set by the development condition setting device is added and the resultant RAW image data is transmitted to external equipment.

According to the present invention, when the captured image data is RAW data, the development condition can be set. The information about the set development condition is added, and the resultant RAW image data can be transmitted to external equipment. Thus, a troublesome operation of setting the development condition of the RAW image data can be omitted on the external equipment, and the developing process can be quickly performed.

To attain the above-mentioned objective, the seventh aspect of the present invention provides an image pickup apparatus based on the first to sixth aspects of the present invention. The apparatus further includes: a matching device which checks whether or not image data transmitted through the communication device matches image data received by the external equipment; and a deletion device which deletes image data transmitted through the communication device from the storage medium when the image data transmitted through the communication device matches the image data received by the external equipment as a result of matching by the matching device.

According to the present invention, the transmitted image data is compared with the image data received by the external equipment. When they match, the transmitted image data is deleted from the storage medium. Thus, image data can be prevented from being mistakenly deleted before the transmission is completely performed. Additionally, by deleting the transmitted image data, the capturing operation can be continuously performed without considering the free space of a storage medium.

According to the image pickup apparatus of the present invention, the operations from capturing an image and fetching image data to issuing a print directive can be smoothly performed.

### BRIEF DESCRIPTION OF THE DRAWINGS

FIG. 1 shows the configuration of the system according to an embodiment of the print system;

FIG. 2 is a front perspective view showing the configuration of the appearance of a digital camera;

FIG. 3 is a rear perspective view showing the configuration of the appearance of a digital camera;

FIG. 4 is a block diagram showing the electric configuration of a digital camera;

FIG. 5 is a block diagram showing the electric configuration of a print server;

FIG. 6 shows an example of a setting screen displayed on a liquid crystal monitor of a digital camera;

FIG. 7 is a flowchart of the procedure of a digital camera when an “immediate transmission mode” is selected;

FIG. 8 is a flowchart of the procedure of a digital camera when a “non-immediate transmission mode 1” is selected;

FIG. 9 is a flowchart of the procedure of transmitting image data when a “non-immediate transmission mode 1” is set;

FIG. 10 is a flowchart of the procedure of a digital camera when a “non-immediate transmission mode 2” is selected;

FIG. 11 is a flowchart of the procedure of transmitting image data when a “non-immediate transmission mode 2” is set;

FIG. 12 is a flowchart of the procedure of a digital camera when a “manual transmission mode 1” is selected;

FIG. 13 is a flowchart of the procedure of a digital camera when “automatic” is selected as a method of specifying the number of prints;

FIG. 14 is a flowchart of the procedure of a digital camera when “confirmed automatic” is selected as a method of specifying the number of prints; and

FIG. 15 is a flowchart of the procedure of operating a print server.

### DETAILED DESCRIPTION OF THE PREFERRED EMBODIMENTS

The best modes for embodying the image pickup apparatus according to the present invention are explained below by referring to the attached drawings.

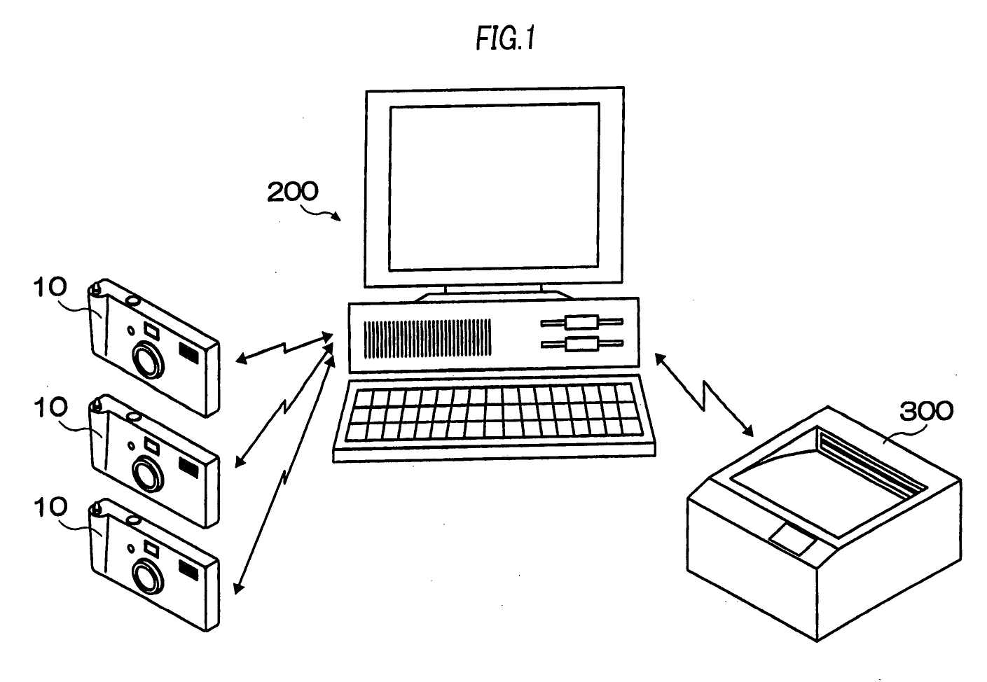

FIG. 1 shows the system configuration which is an example of a print system using a digital camera to which the present invention is applied.

As shown in FIG. 1, the print system is configured by a digital camera 10, a print server 200 for receiving image data transmitted from the digital camera 10 and generating print data, and a printer 300 for printing an image at a request to print from the print server 200.

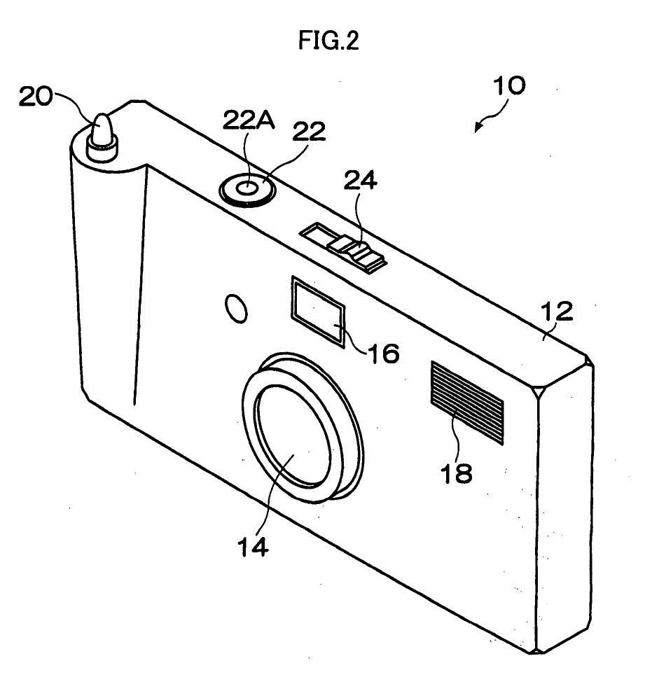

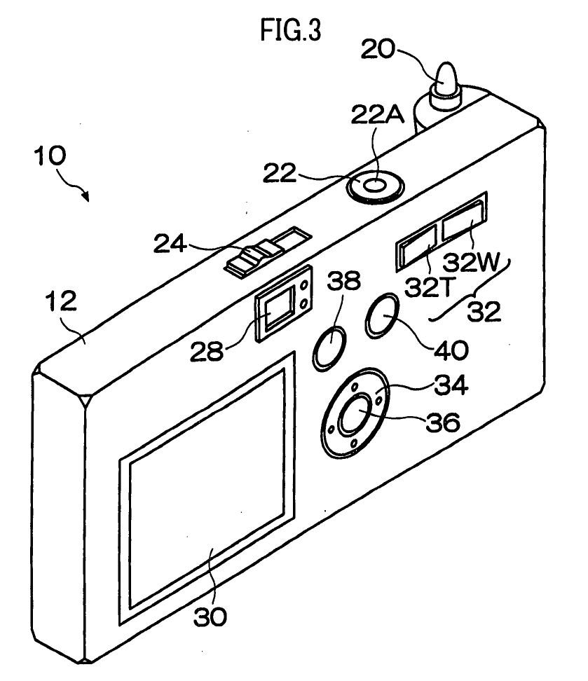

FIGS. 2 and 3 are respectively front and rear perspective views showing the configuration of the appearance of a digital camera to which the present invention is applied.

As shown in FIGS. 2 and 3, a camera body 12 of the digital camera 10 is formed in flat and rectangular shape, and a taking lens 14, a finder window 16, a strobe 18, an antenna 20, etc. are provided for the front. On the top of the camera body 12, a release button 22, a power/mode switch 24, etc. are provided. On the rear, a finder eyepiece 28, a liquid crystal monitor 30, a zoom button 32, a cross button 34, a MENU/OK button 36, a DISP button 38, a BACK button 40, etc. are provided. Furthermore, on the bottom of the camera body not shown in the attached drawings, a media slot and a buttery attachment unit are provided through an open/close cover so that a memory card (storage medium) and a battery can be freely removed and attached.

The taking lens 14 is composed of a collapsible zoom lens, it is extended when the camera is turned on, and returned to the original state when it is turned off.

The antenna 20 is arranged at the left end of the front of the camera body 12, and also functions as a grip of the camera.

The release button 22 is composed of by a 2-step stroke switch which can be half-pressed and fully pressed, and has a touch sensor 22A for detecting the touch of a finger. When the release button 22 is half-pressed, the functions of AE (automatic exposure), AF (autofocus), and AWB (automatic white balance) of the digital camera 10 work. When it is fully pressed, an image recording process is performed (when a still image is captured).

The power/mode switch 24 functions as a power switch for turning on and off the digital camera 10, and as a mode switch for setting the mode of the digital camera 10. It is mounted as freely sliding among the positions of “OFF”, “regeneration”, and “capture”. The digital camera 10 can be turned on by setting the power/mode switch 24 on the position of “regeneration” or “capture”, and can be turned off by setting it on the position of “OFF”. When the power/mode switch 24 is set on the position of “regeneration”, a “regeneration mode” is set. When it is set on the position of “capture”, a “capture mode” is set.

The liquid crystal monitor 30 is configured by a liquid crystal display which can display color images. The liquid crystal monitor 30 is used as an image display panel for displaying a captured image in the regeneration mode, and is also used as a user interface display panel in various settings. Furthermore, when an image is captured, a through image is displayed as necessary for use as an electronic finder for confirmation of the angle of view.

The zoom button 32 is configured by a zoom-tele-button 32T for direction of a zoom for a zooming lens and a zoom-wide-button 32W for direction of a zoom for a wide-angle lens.

The cross button 34 is mounted such that it can be pressed in the four directions, that is, up, down, left, and right, and functions as a directive button for the pressed direction.

The MENU/OK button 36 functions as a button (MENU button) for directing the transition from the normal screen in each mode to the menu screen, and also functions as a button (OK button) directing determination of selected contents, the performance of a process, etc.

The DISP button 38 functions as a button directing a switch for the display contents of a rear display panel, and the BACK button 40 functions as a button directing a cancellation, etc. of an input operation.

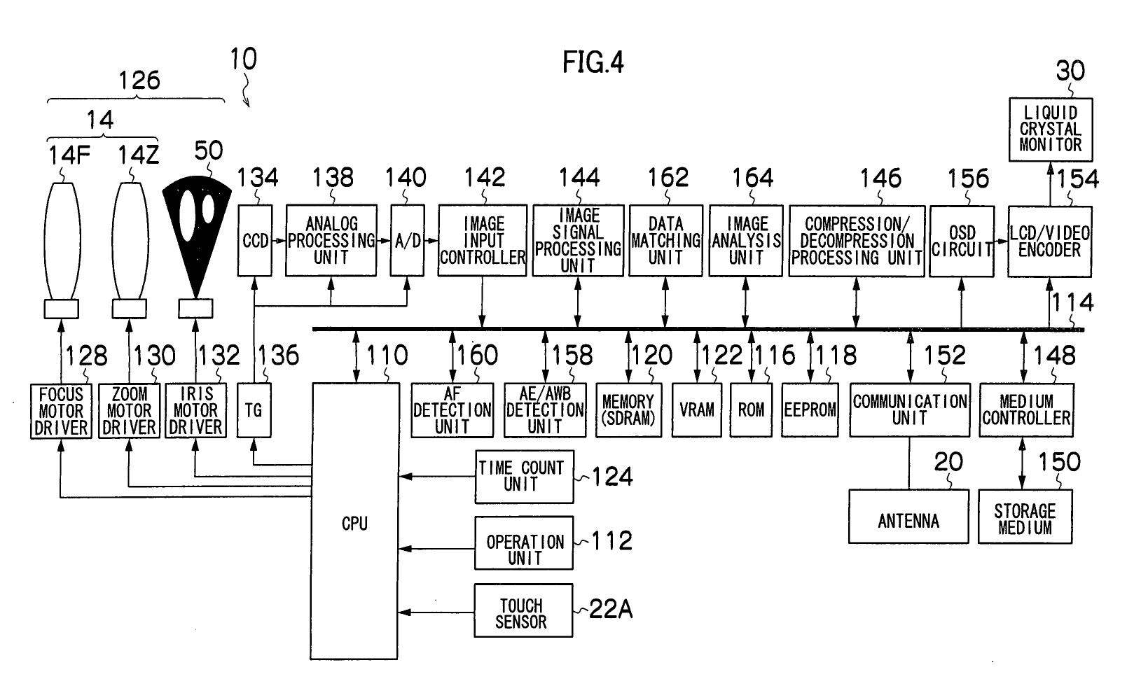

FIG. 4 is a block diagram showing the electric configuration of the digital camera 10. As shown in FIG. 4, the digital camera 10 is configured by a CPU 110, an operation unit (the release button 22, the power/mode switch 24, the zoom button 32, the cross button 34, the MENU/OK button 36, the DISP button 38, the BACK button 40, etc.) 112, ROM 116, EEPROM 118, memory (SDRAM) 120, VRAM 122, the touch sensor 22A, a time count unit 124, an optical unit 126, a focus motor driver 128, a zoom motor driver 130, an iris motor driver 132, an image pickup device 134, a timing generator (TG) 136, an analog processing unit 138, an A/D converter 140, an image input controller 142, an image signal processing unit 144, a compression/decompression processing unit 146, a medium controller 148, a storage medium (memory card) 150, a communication unit 152, an LCD/video encoder 154, an OSD circuit 156, an AE/AWB detection unit 158, an AF detection unit 160, a data matching unit 162, an image analysis unit 164, etc.

The CPU 110 functions as a control unit for controlling the entire operation of the digital camera 10, functions as an arithmetic device which performs various arithmetic operations, and controls each unit according to a predetermined control program based on the input from the operation unit 112.

The ROM 116 connected through a bus 114 stores a control program executed by the CPU 110 and various data, etc. required for control. The EEPROM 118 stores various setting information, etc. about the operations of the digital camera 10 such as user-set information, etc.

The memory (SDRAM) 120 is used as an arithmetic operation area of the CPU 110, and as a temporary storage area of image data, and the VRAM 122 is used as a temporary storage area exclusive for image data to be displayed.

The touch sensor 22A detects the touch of a finger with the release button 22, and outputs the detected contact information to the CPU 110.

The time count unit 124 counts the current time at a command from the CPU 110, and outputs the counted time information to the CPU 110. In addition, it counts the elapsed time from the last capture and the elapsed time from the last touch of a finger with the release button 22 (elapsed time from the detection of the last touch of a finger with the touch sensor 22A), and outputs the information about the counted elapsed time to the CPU 110.

The optical unit 126 is configured by the taking lens 14 and an iris 50.

The taking lens 14 has a focus lens 14F moving forward and backward along the optical axis by the drive of a focus motor not shown in the attached drawings, and a zoom lens 14Z moving forward and backward along the optical axis by the drive of a zoom motor not shown in the attached drawings. The CPU 110 controls the focus of the taking lens 14 by controlling the drive of the focus motor through the focus motor driver 128, and controls the zoom of the taking lens 14 by controlling the drive of the zoom motor through the zoom motor driver 130.

The iris 50 changes the amount of aperture (stop value) by the drive of an iris motor not shown in the attached drawings. The CPU 110 controls the stop value of the iris 50 by controlling the drive of the iris motor through the iris motor driver 132.

The image pickup device 134 is configured by a color CCD, and a large number of photodiodes (photoreceivers) are arranged on its photoreceiving surface. The light incident on the photoreceiving surface of the image pickup device 134 through the optical unit 126 is converted to a signal electric charge depending on the quantity of incident light of each photodiode.

The timing generator (TG) 136 mainly generates a timing signal for drive of the image pickup device 134 under the control of the CPU 110. The image pickup device 134 outputs the signal electric charge accumulated in each photodiode as a video signal (image signal) according to the timing signal applied from the timing generator (TG) 136.

The analog processing unit 138 performs a correlation duplex sampling process (a process of obtaining correct image data by obtaining a difference between the field through component level contained in the output signal of each pixel of an image pickup device and the pixel signal component level so that the noise (especially thermal noise), etc. contained in the output signal of an image pickup device can be reduced) on an image signal sequentially output from the image pickup device 134, and amplifies the signal.

The A/D converter 140 converts the R, G, and B analog image signals output from the analog processing unit 138 to the respective 12-bit digital image signals.

The image input controller 142 contains a line buffer of a predetermined capacity, accumulates the image signal for one image output from the A/D converter 140, and stores it in the memory 120.

The image signal processing unit 144 includes a simultaneous processing unit (a processing unit for interpolating the spatial shift between color signals in the single plate CCD color filter array to simultaneously convert a color signal), a white balance adjustment unit, a gamma correction unit, a contour correction unit, a brightness color difference signal generation unit, etc., and performs a predetermined signal processing on an input digital image signal under the control of the CPU 110, thereby generating image data.

The compression/decompression processing unit 146 performs a compressing process on the input image data under the control of the CPU 110, and generates compressed image data in a predetermined format. In addition, it performs a decompressing process on the input compressed image data, thereby generating non-compressed digital image data.

The medium controller 148 controls the data read and write on the storage medium (memory card) 150 inserted into the media slot under the control of the CPU 110.

The communication unit 152 encodes and decodes the information about image data, etc. under the control of the CPU 110, transmits and receives the resultant data through the antenna 20, and communicates the data with external equipment (the print server 200 in this example). The communication system is not specifically limited, for example, the system such as a radio LAN system, Bluetooth system, an infrared system, etc. can be used. Furthermore, the communication can be established using a public line.

The LCD/video encoder 154 generates a signal for display of an image indicated by image data on the liquid crystal monitor 30 under the control of the CPU 110, and outputs the signal to the liquid crystal monitor 30.

The OSD (on screen display) circuit 156 generates a signal indicating a character, graphics, etc. to be displayed on the liquid crystal monitor 30 under the control of the CPU 110, and outputs the signal to the LCD/video encoder 154.

The AE/AWB detection unit 158 computes a physical quantity necessary for AE control and WB control from an input image signal under the control of the CPU 110.

For example, as the physical quantity required for the AE control, a screen is divided into a plurality of areas (for example, 16×16), and computes the accumulated value of an image signal of R, G, and B for each of the divided area. The CPU 110 detects the brightness (subject brightness) of a subject based on the accumulated value obtained from the AE/AWB detection unit 158, computes the exposure value (capture EV value) appropriate for capturing, and determines a stop value and a shutter speed from the computed capture EV value and a predetermined program diagram.

As the physical quantity required for the AWB control, one screen is divided into a plurality of areas (for example, 16×16), and an average accumulated value for each color of the image signal of R, G, and B is computed for each of the divided areas. The CPU 110 obtains the ratio of R/G and B/G for each divided area from the obtained accumulated values of R, B, and G, and determines the optical source type based on the distribution, etc. in the color space of R/G and B/G of the obtained values of R/G and B/G. According to the white balance adjustment value appropriate for the determined optical source type, for example, the gain value (white balance adjustment value) for the R, G, and B signal of the white balance adjustment unit such that the value of each ratio can be approximately 1 (that is, on one screen, the accumulated ratio value of RGB can be R:T:B nearly equal to 1:1:1).

The AF detection unit 160 computes the physical quantity required for the AF control from the input image signal under the control of the CPU 110. In the digital camera 10 according to the present embodiment, it is assumed that the AF control is performed from the contrast of the image, and the AF detection unit 160 computes a focus evaluation value indicating the freshness of the image from the input image signal. The CPU 110 controls the drive of the focus motor driver 128 such that the focus evaluation value computed by the AF detection unit 160 can be a maximum, thereby controlling the movement of the focus lens 14F.

The data matching unit 162 analyzes the image data, compares the data transmitted through the communication unit 152 with the data received by the destination (the print server 200 in this example) (verify), and outputs the result to the CPU 110 under the control of the CPU 110.

The image analysis unit 164 extracts the face (skin color area) of the person taken in the captured image and counts the number (of the persons: m) under the control of the CPU 110. Then, the count number of persons (m) is output to the CPU 110.

Next, as described above, the procedure of the basic capturing operations of the digital camera 10 is explained below.

As described above, the functions of AE, AF, and AWB of the digital camera 10 work with the release button 22 half-pressed, and the image is recorded with the button fully pressed. When the release button 22 is half pressed, an S1ON signal is input to the CPU 110. In response to the S1ON signal, the CPU 110 performs the processes of AE, AF, and AWB.

First, an image signal output from the image pickup device 134 in response to the S1ON signal is fetched by the image input controller 142 through the analog processing unit 138 and the A/D converter 140, and is stored in the memory 120. The image signal stored in the memory 120 is added to the AE/AWB detection unit 158 and the AF detection unit 160.

The AE/AWB detection unit 158 computes the physical quantity required for the AE control and the AWB control from the input image signal, and outputs the result to the CPU 110. The CPU 110 determines the stop value and the shutter speed based on the output from the AE/AWB detection unit 158, and determines the white balance adjustment value.

The AF detection unit 160 computes the physical quantity required for the AF control from the input image signal, and outputs the result to the CPU 110. The CPU 110 controls the drive of the focus motor driver 128 based on the output from the AF detection unit 160, controls the movement of the focus lens 14F, and brings the main subject into focus of the taking lens 14.

Afterwards, when the release button 22 is fully pressed, an S2ON signal is input to the CPU 110, and in response to the S2ON signal, the CPU 110 performs the recording process on the image.

First, the image pickup device 134 is exposed with the stop value and the shutter speed obtained in the above-mentioned AF process, and a recording image signal is fetched. The image signal output from the image pickup device 134 is fetched to the image input controller 142 through the analog processing unit 138 and the A/D converter 140, and then stored in the memory 120.

The image signal stored in the memory 120 is applied to the image signal processing unit 144 under the control of the CPU 110, and converted to the image data (YC data) comprising brightness data and color difference data. The image data generated by the image signal processing unit 144 is stored in the memory 120, and then added to the compression/decompression processing unit 146, compressed in a predetermined compression format (for example, JPEG), and stored in the memory 120 again.

The CPU 110 records in the storage medium (memory card) 150 the compressed image data stored in the memory 120 as a still image file of a predetermined format (for example, Exit).

In the digital camera 10 according to the present embodiment, image data can be recorded in a RAW format. When data is recorded in the RAW format, the image data (RAW image data) fetched from the image pickup device 134 to the memory 120 through the analog processing unit 138, the A/D converter 140, and the image input controller 142 is recorded as is in the storage medium (memory card) 150.

Then, the procedure of the basic operation of the regenerating process of the digital camera 10 is explained below.

As described above, the digital camera 10 can regenerate an image file recorded on the liquid crystal monitor by setting the mode of the camera in the regeneration mode.

When the power/mode switch 24 is set on the regeneration position and the mode of the camera is set in the regeneration mode, the CPU 110 outputs a command to the medium controller 148, and the image data of the image file last recorded on the storage medium 150 is read.

The read image data of the image file is added to the compression/decompression processing unit 146, and the decompressing process is performed on the data to convert it to uncompressed image data. Then the data is output to the liquid crystal monitor 30 through the LCD/video encoder 154. Thus, the image recorded on the storage medium 150 is regenerated and displayed on the liquid crystal monitor 30.

The frame advance of an image is performed by operating left and right keys of the cross button 34. When the right key is operated, the next image file is read from the storage medium 150, and regenerated and displayed on the liquid crystal monitor 30. When the left key of the cross button 34 is operated, one image file before the current file is read from the storage medium 150, and regenerated and displayed on the liquid crystal monitor 30.

Described above is the procedure of the basic operations of the capturing and regenerating processes of the digital camera 10 according to the present embodiment.

The digital camera 10 according to the present embodiment has the communication function, and can communicate image data, etc. with external equipment (the print server 200 in this example) by wireless. Image data is transmitted in the four transmission modes, that is, an immediate transmission mode in which data is automatically transmitted immediately after a capturing operation, a non-immediate transmission mode 1 in which data is automatically transmitted when predetermined elapsed time passes from the last capture, a non-immediate transmission mode 2 in which data is automatically transmitted when predetermined elapsed time passes from the last touch with the release button, and a manual transmission mode in which data is manually transmitted. A user can optionally select any mode.

Image data is also designed with the settings of necessity/non-necessity of printing for image data to be transmitted, printing condition (number of prints, print size, etc.), processes of transmitted image data (storage or deletion), etc. The information can be added in transmitting image data.

When the image data to be transmitted is RAW image data, the settings of development condition (image quality, brightness, white balance, vividness, sharpness, etc.) can be made. By adding the information about the development condition, the image data can be transmitted.

The operation in the process of transmitting the above-mentioned image data is explained later with the explanation of the operation of the print server after first explaining the configuration of the print server 200.

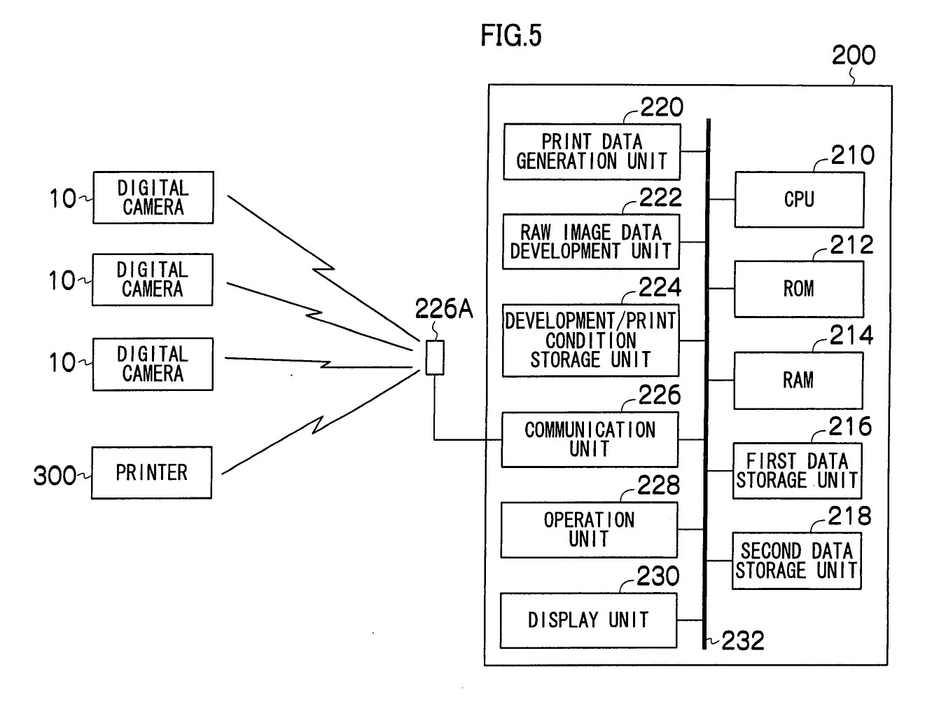

FIG. 5 is a block diagram of the electric configuration of the print server. As shown in FIG. 5, the print server 200 is configured by a CPU 210, ROM 212, RAM 214, a first data storage unit 216, a second data storage unit 218, a print data generation unit 220, a RAW image data development unit 222, a development/print condition storage unit 224, a communication unit 226, an operation unit 228, and a display unit 230.

The CPU 210 functions as a control unit for integrating and controlling the entire operations of the print server, and controls each unit according to a predetermined control program. The ROM 212 connected through a bus 232 stores a control program executed by the CPU 210 and various data, etc. required for control, and the RAM 214 is used as a work area, etc. of the CPU 210.

The first data storage unit 216 is used as a work area in printing image data received from the digital camera 10 under the control of the CPU 210. That is, it is used in temporarily storing image data received from the digital camera 10, and in temporarily storing print data to be transmitted to the printer 300.

On the other hand, the second data storage unit 218 is used as a storage area of image data received from the digital camera 10 under the control of the CPU 210.

The first data storage unit 216 and the second data storage unit 218 are configured by a large capacity storage device, for example, a hard disk, a DVD, an MO, etc. The storage area of one storage device can be divided into the first data storage unit 216 and the second data storage unit 218, or the first data storage unit 216 can be configured by RAM, and only the second data storage unit 218 can be configured by a large capacity storage device such as a hard disk, etc. In the present embodiment, a storage area is divided and used, thereby enabling one hard disk to be used as the first data storage unit 216 and the second data storage unit 218.

The print data generation unit 220 generates print data to be output to the printer 300 from the image data received from the digital camera 10 under the control of the CPU 210 (converts the data to a data format applicable to the printer 300).

The RAW image data development unit 222 develops the RAW image data received from the digital camera 10 based on a predetermined development condition under the control of the CPU 210. When a development condition is assigned to RAW image data received from the digital camera 10, the RAW image data development unit 222 develops the received RAW image data according to the condition. When a development condition is not assigned to the received RAW image data, the received RAW image data is developed according to a predetermined development condition.

The development/print condition storage unit 224 stores a predetermined development condition of RAW image data and a predetermined print condition (number of prints, print size). If the image data received from the digital camera 10 is RAW image data, and no development condition is assigned to the RAW image data, then the received RAW image data is developed using the development condition stored in the development/print condition storage unit 224. If the image data received from the digital camera 10 is not assigned a print condition, then the received image data is printed using the predetermined print condition stored in the development/print condition storage unit 224. The development/print condition storage unit 224 is configured by, for example, non-volatile memory such as EEPROM, etc.

The communication unit 226 encodes or decodes the information about image data, etc. under the control of the CPU 210 and transmits or receives it through an antenna 226A, and communicates data with the digital camera 10 and the printer 300.

The operation unit 228 is configured by, for example, a keyboard, a mouse, etc. for use in setting a print mode, inputting a print directive, etc.

The display unit 230 is configured by, for example, a liquid crystal display, and is used as an operation screen when displaying the operations of the entire system and making various settings.

The printer 300 has a communication device for wireless communication with the communication unit 226 of the print server 200, prints an image on paper or other recording sheet based on the print data transmitted from the print server 200.

The printing system is not specifically limited, but any printing system such as a TA system, an ink jet system, a laser system, etc. can be adopted.

Described below is the operation in the printing process in the print system with the above-mentioned configuration.

The entire flow of the printing process is first capturing an image by the digital camera 10, transmitting the captured image data to the print server 200, generating print data by the print server 200, and then outputting the data from the printer 300.

As described above, when image data is transmitted to the print server 200, the digital camera 10 has the four transmission modes, that is, an immediate transmission mode in which data is automatically transmitted immediately after a capturing operation, a non-immediate transmission mode 1 in which data is automatically transmitted when predetermined elapsed time passes from the last capture, a non-immediate transmission mode 2 in which data is automatically transmitted when predetermined elapsed time passes from the last touch with the release button, and a manual transmission mode in which data is manually transmitted. A user can optionally select any mode.

Image data is also designed with the settings of necessity/non-necessity of printing for image data to be transmitted, printing condition, processes of transmitted image data, etc. The information can be added in transmitting image data.

When the image data to be transmitted is RAW image data, the settings of development condition can be made. By adding the information about the development condition, the image data can be transmitted.

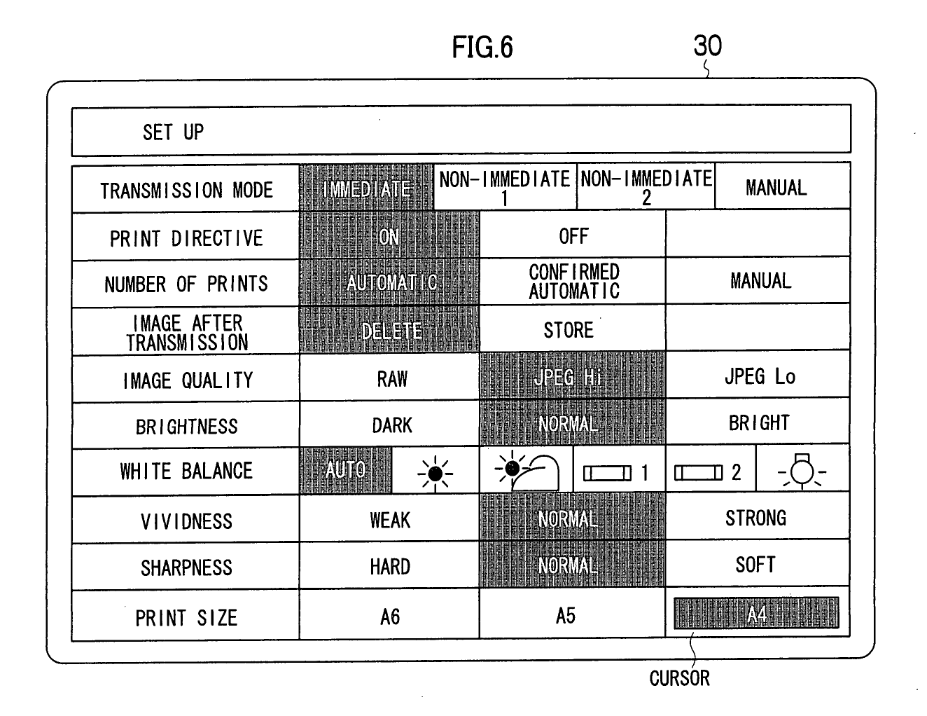

These settings are made using the liquid crystal monitor 30 of the digital camera 10. FIG. 6 shows an example of the setting screen displayed on the liquid crystal monitor 30. The setting screen is called by selecting the item of “SET UP” from the menu screen displayed on the liquid crystal monitor 30 by pressing the MENU/OK button 36. The user follows the display on the setting screen, moves a cursor using the cross button 34, and selects a desired process condition for each item, thus making settings.

For example, when the immediate transmission mode is selected for the item of “transmission mode”, the cursor is moved to the column of “immediate”, and the MENU/OK button 36 is pressed. Thus, the immediate transmission mode is selected as a transmission mode. The background color and the character color of the selected item are inverted on the display (in the example shown in FIG. 6, the selected item is displayed as outline typeface).

As shown in FIG. 6, the digital camera 10 according to the present embodiment has ten setting items of: (1) “transmission mode”, (2) “print directive”, (3) “number of prints”, (4) “image after transmission”, (5) “image quality”, (6) “brightness”, (7) “white balance”, (8) “vividness”, (9) “sharpness”, and (10) “print size”. These items can be optionally set by a user.

The item (1) “transmission mode” is used in setting the transmission timing of captured image data, and can be selected from among three modes, that is, “immediate” indicating a mode for automatic transmission immediately after capture (immediate transmission mode), “non-immediate 1” indicating a mode for automatic transmission at predetermined elapsed time after the last capture (non-immediate transmission mode 1), “non-immediate 2” indicating a mode for automatic transmission at predetermined elapsed time after the last touch with the release button (non-immediate transmission mode 2), and “manual” indicating a mode for manual transmission (manual transmission mode).

The item (2) “print directive” is used in selecting necessity/non-necessity of print of captured image data, and “ON” is selected when printing is required, and “OFF” is selected when it is not required.

The item (3) “number of prints” is used in setting the number of prints when image data is printed. The item can be selected from among “automatic”, “confirmed automatic”, and “manual”. “Automatic” refers to automatically detecting the number of persons taken in a captured image from image data, and automatically setting the number of prints equal to the number of detected persons. On the other hand, “confirmed automatic” refers to a user determining after confirmation of the number of automatically detected persons. When there is an error in the number of automatically recognized persons, the number can be corrected. “Manual” refers to manually inputting the number of prints. The practical processes of “automatic” and “confirmed automatic” are described later.

The item (4) “image after transmission” refers to setting of transmitted image data, and “deletion” indicating the deletion after transmission or “storage” indicating the storage after transmission can be selected.

The item (5) “image quality” is used in setting the quality of image of the image data to be recorded/transmitted, and can be selected from among three items, that is, “RAW” for recording/transmitting captured image data as RAW image data, “JPEG Hi” for compression of captured image data at a low compression rate for recording/transmission of the data, and “JPEG Lo” for compression of captured image data at a high compression rate for recording/transmission of the data.

The items (6) “brightness”, (7) “white balance”, (8) “vividness”, and (9) “sharpness” are used for setting the development condition of the RAW image data.

Among them, (6) “brightness” is used in setting the brightness of an image. “Dark” is selected when developing a little dark image. “Normal” is selected when developing an image with normal brightness. “Bright” is selected when developing a bright image.

(7) “White balance” is used in setting the white balance (type of optical source) of an image. “AUTO” is used for automatic adjustment. “Fine (mark of the sun)” specifies capturing outdoor on a fine day. “Shade (mark of cloud)” specifies capturing in the shade. “Fluorescent light 1 (mark of fluorescent light and 1)” specifies capturing under a daylight fluorescent lamp. “Fluorescent light 2 (mark of fluorescent light and 2)” specifies capturing under an incandescent lamp. “Electric bulb (mark of electric bulb)” specifies capturing under an electric bulb or incandescent lamp. A user can select one of the six levels.

(8) “Brightness” is used in setting the vividness (intensity) of an image. “Weak” indicates a calm tone. “Normal” indicates a normal tone. “Strong” indicates a very vivid tone. A user can select one of the three levels.

(9) “Sharpness” is used in setting the sharpness of an image. “Hard” indicates developing an image with the outline highlighted. “Normal” indicates developing an image with normal sharpness. “Soft” indicates developing an image with soft outline. A user can select one of the three levels.

(10) “Print size” is used in setting a print size of an image to be transmitted. “A6” indicates the print size of “A6”. “A5” indicates the print size of “A5”. “A4” indicates the print size of “A4”. A user can select one of the three sizes.

A user selects a desired process condition for each item. The selected process condition of each item is recorded as user-set information in the EEPROM 118.

The above-mentioned setting items are only examples, and it is not necessary to allow the digital camera to set all these items. For example, it is not necessary for a camera not having the function of recording RAW image data to have a setting item for a development condition of RAW image data. It is also possible to provide any setting item other than the above-mentioned items to make a furthermore detailed setting on the digital camera side. It can be appropriately set depending on the camera.

Described next is the operation of the process of the digital camera 10 depending on the condition set on the setting screen.

First, the operation of the process of the digital camera 10 performed when the “immediate transmission mode” is selected as a transmission mode is described below.

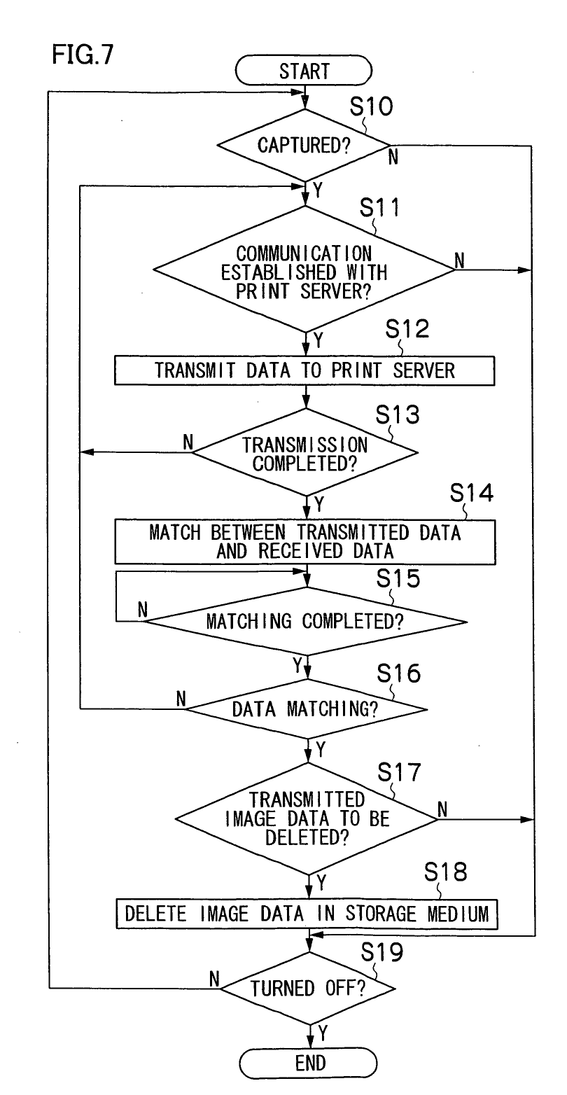

FIG. 7 is a flowchart of the procedure of the digital camera 10 when the “immediate transmission mode” is selected as a transmission mode.

First, the CPU 110 determines whether or not an image has been captured (step S10). If it has been captured, the CPU 110 determines whether or not the communication with the print server 200 has been established after recording the captured image data (step S11).

If the communication with the print server 200 has not been established, the process of transmitting data is suspended, and control is passed to step S19. If the communication has been established with the print server 200, the process of transmitting the captured image data is started (step S12).

Afterwards, the CPU 110 determines whether or not data transmission to the print server 200 has been completed (step S13). If it determines YES, the transmitted data is compared (step S14). That is, the data matching unit 162 compares the data transmitted from the digital camera 10 with the data received by the print server 200. Then, it is determined whether or not the matching process has been completed (step S15). If it is determined that the matching process is completed, it is determined based on the comparison result of the data matching unit 162 whether or not the transmitted data matches the received data (step S16).

If it is determined that the data do not match each other, control is returned to step S11, and the process of transmitting image data is performed. On the other hand, if it is determined that the data match each other, the process of transmitting data is completed, and it is determined whether or not the transmitted image data is to be deleted from the storage medium 150 (step S17). The determination is performed according to the user set information recorded on the EEPROM 118. If the user has set “delete” for the “image data after transmission”, the image file of the transmitted image data is deleted from the storage medium 150 (step S18). If the user has set “store” for the “image data after transmission”, the file is not deleted, and is to be recorded as is on the storage medium 150.

Afterwards, it is determined whether or not the camera has been turned off (step S19). If it has not been turned off, control is returned to step S10, and the above-mentioned process is repeated.

Thus, if the “immediate transmission mode” is selected as a transmission mode, the image data is transmitted to the print server 200 immediately after the capturing process.

In the example above, captured image data is temporarily recorded on the storage medium 150, and then transmitted. However, it is also possible to record the data on the storage medium 150 after the transmission process depending on the setting of the “image data after transmission”.

Described below is the process of the digital camera 10 when the “non-immediate transmission mode 1 ” is selected as a transmission mode.

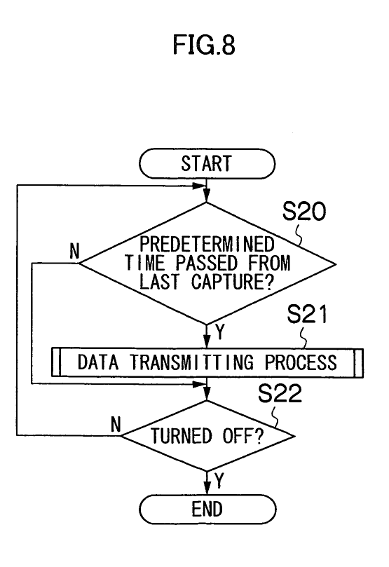

FIG. 8 is a flowchart of the procedure of a digital camera 10 when the “non-immediate transmission mode 1” is selected as a transmission mode.

As described above, in the non-immediate transmission mode 1, when predetermined time passes after last capture, it is determined that the system is in the non capture state, and the process of transmitting image data is performed.

First, the CPU 110 determines whether or not predetermined time has passed from the last capture (step S20). That is, the elapsed time from the last capture is obtained from the time count unit 124, and it is determined whether or not predetermined time is exceeded. The predetermined time can be optionally set by a user, and the user set value on the menu screen, etc. is recorded on the EEPROM 118.

If it is determined that predetermined time has not passed yet from the last capture, the CPU 110 determines whether or not the camera has been turned off (step S22). If it has not been turned off, control is returned to step S20, and it is determined again whether or not predetermined time has passed after the last capture. If it is determined that predetermined time has passed from the last capture, the CPU 110 performs the process of transmitting image data (step S21).

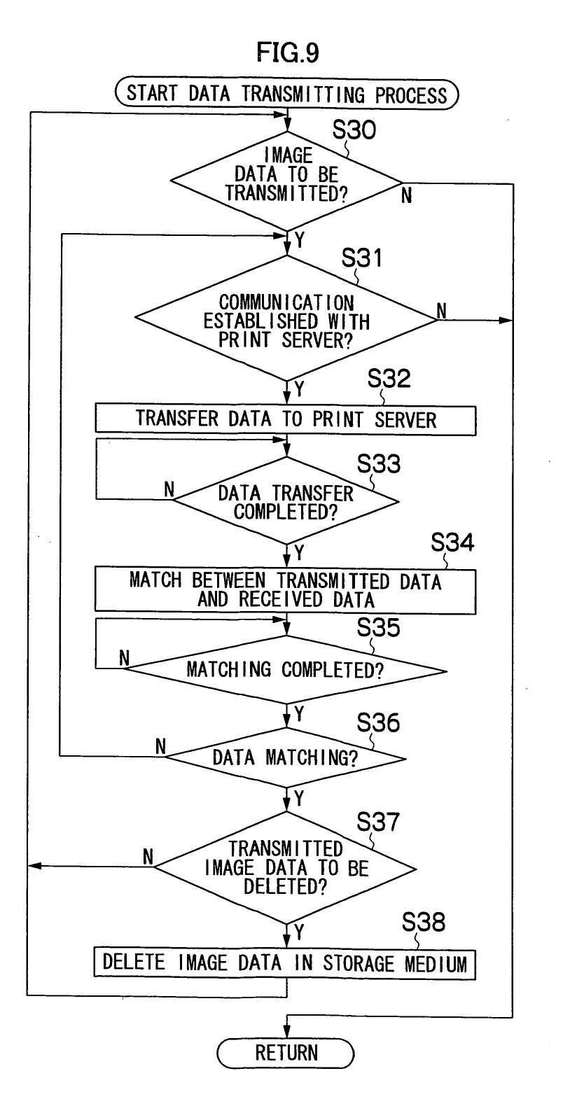

FIG. 9 is a flowchart of the procedure of transmitting image data when the “non-immediate transmission mode 1” is set.

First, the CPU 110 determines the presence/absence of image data to be transmitted (step S30). If there is no image data to be transmitted, the process of transmitting image data is completed, and control is passed to step S21 again. If it is determined that there is image data to be transmitted, then it is determined whether or not the communication with the print server 200 has been established (step S31). If it is determined that the communication with the print server 200 has not been established, the process of transmitting data is terminated, and control is returned to step S21. If it is determined that the communication with the print server 200 has been established, the process of transmitting captured image data is started (step S32).

Afterwards, the CPU 110 determines whether or not the data transmission to the print server 200 has been completed (step S33). If it is determined that the transmission has been completed, the process of matching transmitted data is performed (step S34). Then, it is determined whether or not the matching process has been completed (step S35). If it is determined that the matching process has been completed, it is determined based on the matching result of the data matching unit 162 whether or not the transmitted data matches the received data (step S36).

If the data do not match each other, control is returned to step S31, and the process of transmitting image data is performed again. On the other hand, if it is determined that the data match each other, the process of transmitting data is completed, and it is determined whether or not the transmitted image data is to be deleted from the storage medium 150 (step S37). Then as described above, if the user has set “delete” for the “image data after transmission”, the image file of the transmitted image data is deleted from the storage medium 150 (step S38). If the user has set “store”, the file is not deleted, and is recorded as is on the storage medium 150.

Then, control is returned to step S30, and the presence/absence of the image data to be transmitted is determined again, and the process is performed based on the determination result.

As described above, if predetermined time has passed from the last capture in the non-immediate transmission mode 1, it is determined that the system is in the non capture state, and the process of transmitting image data is performed.

In the example above, the transmitting process is continued until there is no image data to be transmitted. However, when a capturing process is performed while data is being transmitted, the transmitting process is suspended and the capturing process can be performed.

The process of the digital camera 10 when the “non-immediate transmission mode 2” is selected as a transmission mode is described below.

As described above, in the “non-immediate transmission mode 2”, when predetermined time passes after last touch with the release button 22, it is determined that the system is in the non capture state, and the process of transmitting image data is started.

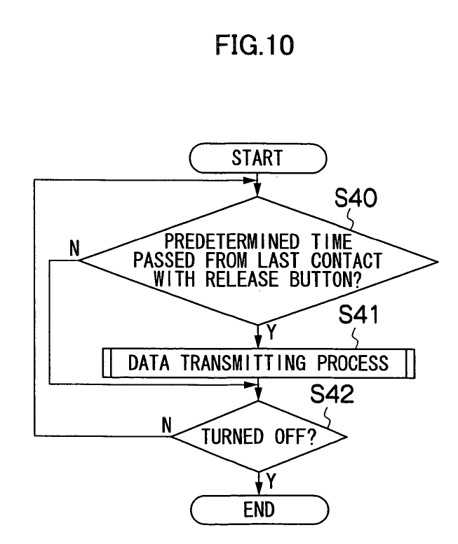

FIG. 10 is a flowchart of the procedure of a digital camera 10 when a “non-immediate transmission mode 2” is selected as a transmission mode.

First, the CPU 110 determines whether or not predetermined time has passed from the last touch with the release button 22 (step S40). That is, the elapsed time from the last touch with the release button 22 (the elapsed time from the detection of the last touch of a finger with the touch sensor 22A) is obtained from the time count unit 124, and it is determined whether or not predetermined time is exceeded. The predetermined time can be optionally set by a user, and the user set value on the menu screen, etc. is recorded on the EEPROM 118.

If it is determined that predetermined time has not passed yet from the last touch with the release button 22, the CPU 110 determines whether or not the camera has been turned off (step S42). If it has not been turned off, control is returned to step S40, and it is determined again whether or not predetermined time has passed after the last touch with the release button 22. If it is determined that predetermined time has passed from the last touch with the release button 22, the CPU 110 performs the process of transmitting image data (step S41).

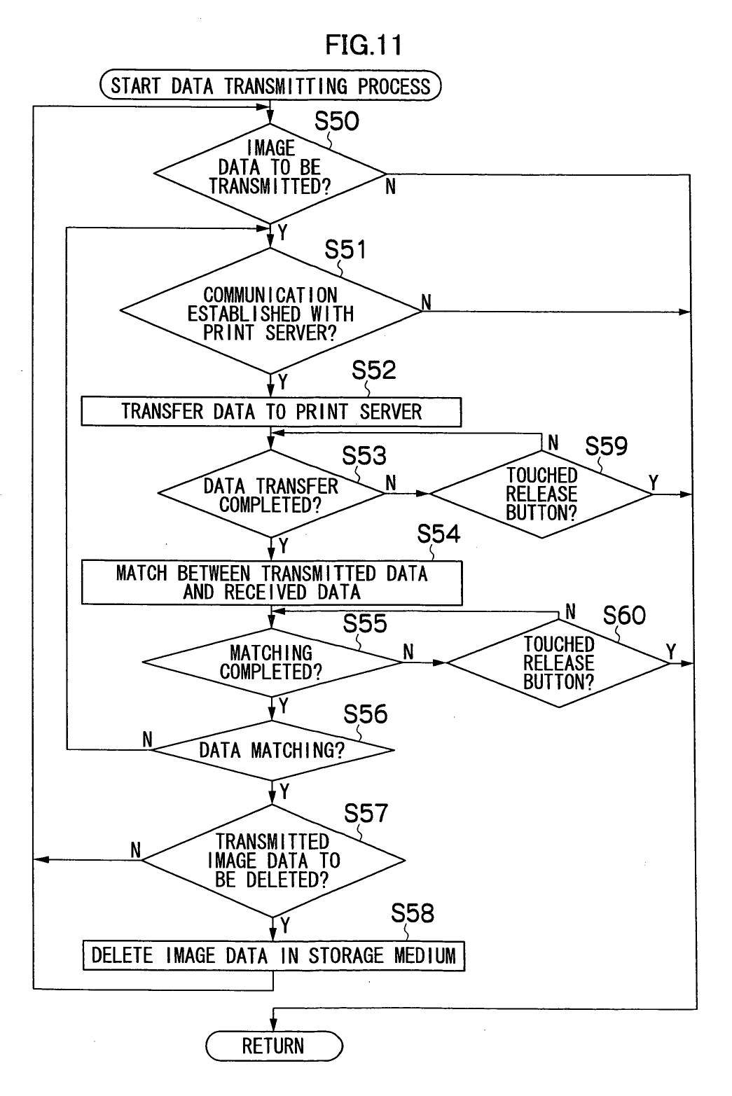

FIG. 11 is a flowchart of the procedure of transmitting image data when the “non-immediate transmission mode 2” is set.

First, the CPU 110 determines the presence/absence of image data to be transmitted (step S50). If there is no image data to be transmitted, the process of transmitting image data is completed, and control is passed to step S41 again. If it is determined that there is image data to be transmitted, then it is determined whether or not the communication with the print server 200 has been established (step S5 1). If it is determined that the communication with the print server 200 has not been established, the process of transmitting data is terminated by the CPU 110, and control is returned to step S41. If it is determined that the communication with the print server 200 has been established, the process of transmitting captured image data is started (step S52).

Afterwards, the CPU 110 determines whether or not the data transmission to the print server 200 has been completed (step S53). If it is determined that the data transmission to the print server 200 has not been completed, the CPU 110 determines based on the output from the touch sensor 22A whether or not a finger has touched the release button 22 (step S59). If it is determined that a finger has touched the release button 22, the process of transmitting image data is suspended, and control is returned to step S41. It is determined that a finger has not touched the release button 22, control is returned to step S53, and it is determined again whether or not data transmission to the print server 200 has been completed.

If it is determined that data transmission has been completed, the CPU 110 performs the process of matching transmitted data (step S54), and determines whether or not the matching process has been completed (step S55). If it is determined that the matching process has not been completed, the CPU 110 determines based on the output from the touch sensor 22A whether or not a finger has touched the release button 22 (step S60). If it is determined that a finger has touched the release button 22, then the process of transmitting image data is suspended, and control is returned to step S41. If it is determined that a finger has not touched the release button 22, then control is returned to step S55, and it is determined again whether or not the matching process has been completed.

If it is determined that the matching process has been completed, the CPU 110 determines based on the matching result of the data matching unit 162 whether or not the transmitted data matches the received data (step S56). If the data do not match each other, control is returned to step S51, and the process of transmitting image data is performed again. On the other hand, if it is determined that the data match each other, the process of transmitting data is completed, and it is determined whether or not the transmitted image data is to be deleted from the storage medium 150 (step S57). Then as described above, if the user has set “delete” for the “image data after transmission”, the image file of the transmitted image data is deleted from the storage medium 150 (step S58). If the user has set “store”, the file is not deleted, and is recorded as is on the storage medium 150.

Then, control is returned to step S50, and the presence/absence of the image data to be transmitted is determined again, and the process is performed based on the determination result.

As described above, if predetermined time has passed from the last touch of a finger with the release button 22 in the non-immediate transmission mode 2, it is determined that the system is in the non capture state, and the process of transmitting image data is performed.

In the present embodiment, the touch of a finger is detected by the touch sensor 22A of the release button 22. However, a “half press” or a “full press” on the release button 22 can be detected to recognize the contact of a finger with the release button 22.

In addition, an operation button other than the release button can be used in detecting contact, and the process of transmitting image data can be performed when predetermined time passes after the last contact of a finger with the operation button. For example, the zoom button 32 can be used in detecting contact, and the process of transmitting image data can be performed when predetermined time passes after the last contact of a finger with the release button 22 or zoom button 32. Furthermore, all operation buttons used in the capturing process can be counted in detecting contact, and if predetermined time has passed after the last contact of a finger with the operation buttons, the process of transmitting image data can be performed.

Described below is the digital camera 10 when the “manual transmission mode” is selected as a transmission mode.

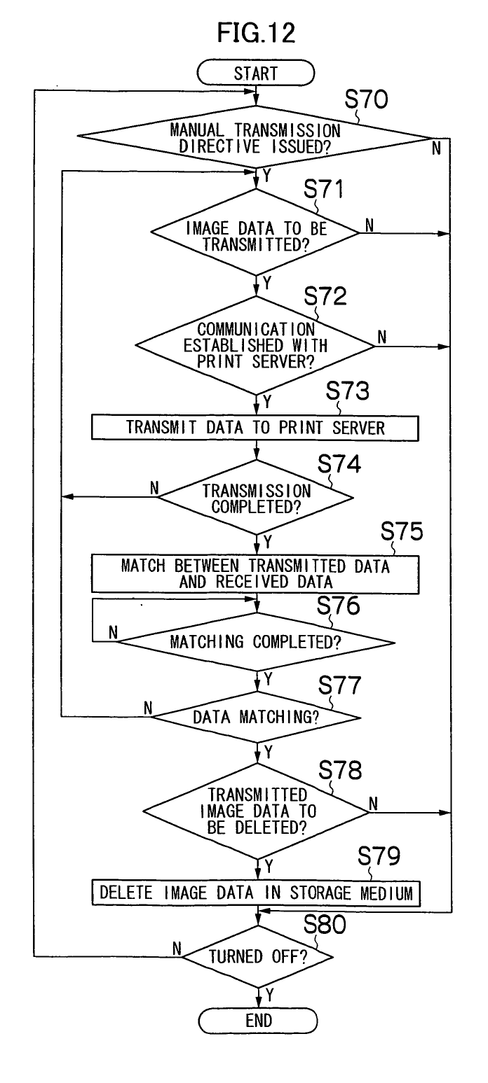

FIG. 12 is a flowchart of the procedure of the digital camera 10 when the “manual transmission mode” is selected as a transmission mode.

First, the CPU 110 determines whether or not a user has issued a manual transmission directive (step S70). A manual transmission directive is assumed to be issued on the menu screen displayed on the liquid crystal monitor 30. In addition, an exclusive transmission button can be provided for the camera body 12 so that a transmission directive can be issued with the transmission button pressed.

If it is determined that a manual transmission directive has been issued, the CPU 110 determines the presence/absence of the image data to be transmitted (step S71). If there is no image data to be transmitted, the process of transmitting image data is completed, and control is passed to step S80. If it is determined that there is image data to be transmitted, then it is determined whether or not the communication with the print server 200 has been established (step S72). If it is determined that the communication with the print server 200 has not been established, the CPU 110 terminates the process of transmitting data, and control is passed to step S80. If it is determined that the communication with the print server 200 has been established, the process of transmitting image data is started (step S73).

Then, the CPU 110 determines whether or not the data transmission to the print server 200 has been completed (step S74). If it is determined that the transmission has been completed, the transmitted data is compared (step S75). It is determined whether or not the matching process has been completed (step S76). If it is determined that the matching process has been completed, then it is determined based on the matching result of the data matching unit 162 whether or not the transmitted data matches the received data (step S77).

If it is determined that the data do not match each other, control is returned to step S72, and the process of transmitting image data is performed. If it is determined that the data match each other, the process of transmitting data is terminated, and it is determined whether or not the transmitted image data is to be deleted from the storage medium 150 (step S78). When a user sets “delete” for the “image data after transmission” as determined above, the image file of the transmitted image data is deleted from the storage medium 150 (step S79). If the user sets “store”, the file is not deleted, and recorded as is on the storage medium 150.

Then, it is determined whether or not the camera has been turned off (step S80). If it has not been turned off, control is returned to step S71, and the above-mentioned processes are repeated.

As described above, if the “manual transmission mode” is selected as a transmission mode, the image data recorded on the storage medium 150 and to be transmitted is transmitted to the print server 200 at the transmission directive from a user.

When “automatic” is selected as a method of specifying the number of prints (when the item of “number of prints” is set to “automatic“), the process of the digital camera 10 is explained as follows.

As described above, when the item of “number of prints” is set to “automatic”, the number of persons taken in the captured image is automatically detected, and the number of detected persons is automatically set as the number of prints.

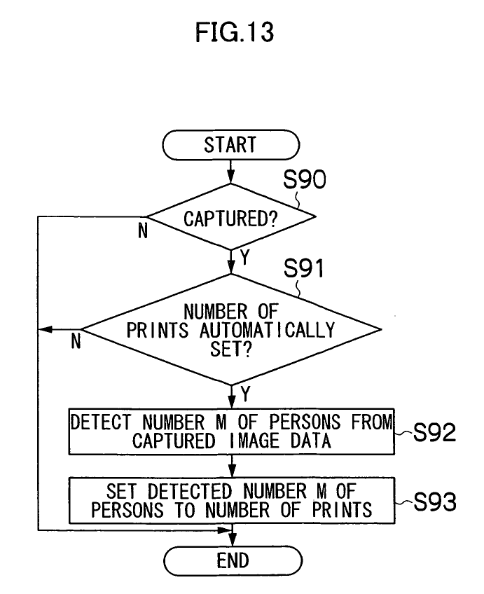

FIG. 13 is a flowchart of the procedure of the digital camera 10 when “automatic” is selected as a method of specifying the number of prints.

First, the CPU 110 determines whether or not an image has been captured (step S90). If it is determined that an image has been captured, the CPU 110 determine whether or not the item of the number of prints is set to “automatic” (step S91). The determination is performed according to the user set information recorded on the EEPROM 118. If it is determined that the item of the “number of prints” is set to “automatic”, the CPU 110 performs the process of detecting the persons taken in the captured image (step S92). That is, the image data obtained by the capture is added to the image analysis unit 164, and the number m of the persons taken in the captured image is counted. The obtained number m is set as the number of prints (step S93).

When the item of “number of prints” is set to “automatic”, the number of persons taken in the captured image is automatically detected, and the detected number is automatically set as the number of prints. Thus, the trouble of setting the number of prints can be omitted, and the operation from capturing to printing can be smoothly performed.

When “confirmed automatic” is selected as the method of specifying the number of prints (when the item of “number of prints” is set to “confirmed automatic”), the process of the digital camera 10 is explained as follows.

As described above, when the item of “number of prints” is set to “confirmed automatic”, a user first confirms the number of persons automatically detected from the captured image, and then the user can correct it as necessary.

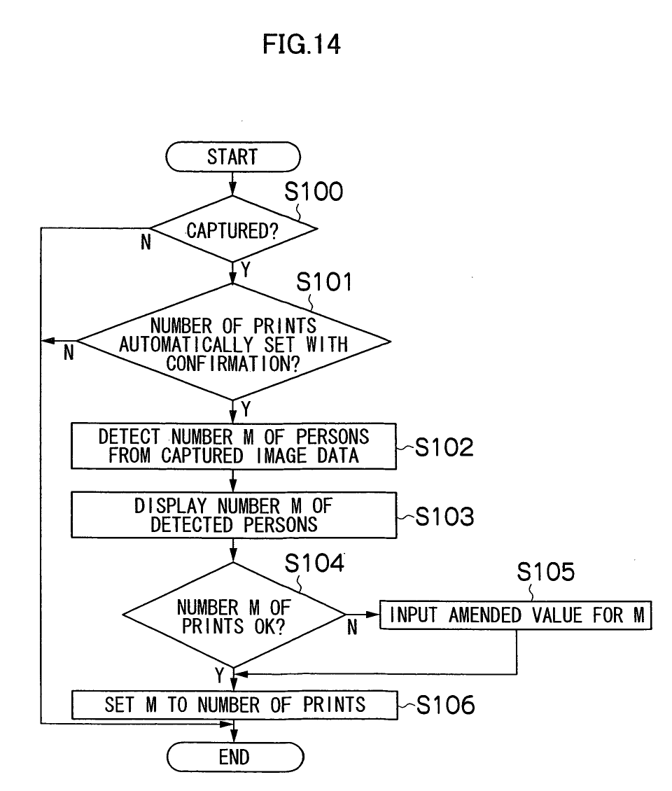

FIG. 14 is a flowchart of the procedure of the digital camera 10 when “confirmed automatic” is selected as a method of specifying the number of prints.

First, the CPU 110 determines whether or not an image has been captured (step S100). If it is determined that an image has been captured, the CPU 110 determines whether or not the item of the number of prints is set to “confirmed automatic” (step S101). The determination is performed according to the user set information recorded on the EEPROM 118. If it is determined that the item of the “number of prints” is set to “confirmed automatic”, the CPU 110 performs the process of detecting the persons taken in the captured image (step S 103). Then, the detected number m of persons is set to the number of prints and displayed on the liquid crystal monitor 30. At this time, the CPU 110 simultaneously allows the captured image to be displayed on the liquid crystal monitor. For example, the number m of prints is displayed at the lower right corner of the captured image. The user sees the number m of prints displayed on the liquid crystal monitor 30, and confirmed whether or not the number is to be corrected. If it is not necessary to correct the number, the user presses the MENU/OK button 36, and confirms the number m of prints.

If it is necessary to correct the number, it is corrected using the up key and the down key of the cross button 34. The CPU 110 determines whether or not the number m of prints has been corrected using the up key and the down key of the cross button 34 (step S104). The number of prints increases when the up key of the cross button 34 is pressed (increases with the number of times of pressing the key), and decreases when the down key of the cross button 34 is pressed (decreases with the number of times of pressing the key). When the CPU 110 determines that the up or down key of the cross button 34 has been pressed, it corrects the number m of prints depending on the frequency of the pressing operation. At this time, the display on the liquid crystal monitor 30 is also corrected.

As described above, when the number m of prints is to be corrected, it is corrected using the up and down keys of the cross button 34. After the correction, the MENU/OK button 36 is pressed to confirm the number. When the number of prints is confirmed, the CPU 110 sets the confirmed number of prints (step S 106).

As described above, when the item of the “number of prints” is set to “confirmed automatic”, a user can confirm the number of persons automatically detected from the captured image, and then correct it as necessary. Thus, although the result of the automatically recognition is erroneous, it can be easily corrected, thereby smoothly performing the operations from capture to printing.

When the item of “number of prints” is set to “manual”, the number of prints is manually input. In this case, the number of prints can be input immediately after the capture, or the number of prints can be input during regeneration of the recorded image data.

When the number of prints is input immediately after the capture, the input screen of the number of prints can be automatically displayed on the liquid crystal monitor 30 upon completion of capture. The input screen is displayed with the number of prints (initial value is 0) displayed at the lower right corner of the captured image as described above, and the number of prints is input by adjusting the number using the up and down keys of the cross button 34.

When the number of prints is input during the regeneration of the captured image data, for example, the input screen of the number of prints can be called from the regeneration menu. As described above, the input screen is displayed with the number of prints (initial value is 0) displayed at the lower right corner of the captured image as described above, and the number of prints is input by adjusting the number using the up and down keys of the cross button 34.

The input information about the number of prints is recorded in, for example, the header portion of the image file. When image data is transmitted, the information is transmitted with the image data to the print server 200. Other information about the print condition, the information about the development condition of RAW image data, information about a print directive, etc. are recorded in the header portion of the image file, and transmitted to the print server 200 with image data when the image data is transmitted. The information can be recorded in the file separate from the image data, and the information can be simultaneously transmitted when the image data is transmitted.

Next, the operation of the print server 200 which processes the image data transmitted from the digital camera 10 is described below.

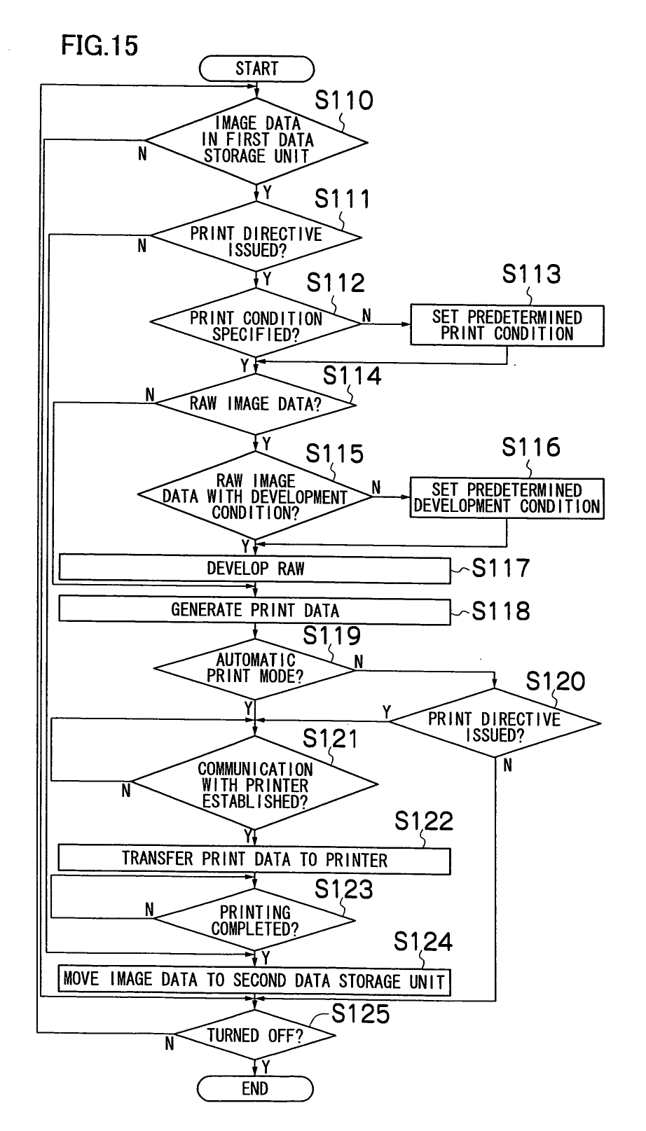

FIG. 15 is a flowchart of the procedure of the print server 200.

As described above, the image data transmitted from the digital camera 10 is received by the communication unit 226, and temporarily stored in the first data storage unit 216. The CPU 210 of the print server 200 determines whether or not there is image data in the first data storage unit 216 (step S110).

When it is determined that there is image data in the first data storage unit 216, the CPU 210 determines whether or not there is a print directive in the image data (step S111). That is, it is determined whether or not the print directive in the image data is set as ON.

If it is determined that the print directive is set as OFF (including the case where there is no information about the print directive), the CPU 210 passes control to step S124, and performs the process of recording the received image data (step S124). That is, the image data in the first data storage unit 216 is not printed as is, but moved to the second data storage unit 218 (moved to the second data storage unit 218 without generating print data).

On the other hand, when it is determined that the print directive is set as ON, the CPU 210 determines whether or not a print condition is set for the image data (step S112). That is, it is determined whether or not the number of prints and a print size are specified in the image data. If it is determined that a print condition is not set, the CPU 110 reads a predetermined print condition stored in the development/print condition storage unit 224, and sets it as the print condition of the received image data.

Afterwards, the CPU 110 determines whether or not the received image data is RAW image data (step S114). If it is determined that the data is not RAW image data, then control is passed to step S 118, and the process of generating print data is performed (step Si 18). That is, the received image data is added to the print data generation unit 220, thereby generating the print data.

On the other hand, if it is determined that the received image data is RAW image data, the CPU 210 determine whether or not a development condition is added to the RAW image data (step S115). If it is determined that no development condition is added, the CPU 110 reads the predetermined development condition stored in the development/print condition storage unit 224, and sets the condition as the development condition of the received RAW image data (step S116). Based on the set development condition, the developing process is performed (step S117). That is, the set development condition and RAW image data are added to the RAW image data development unit 222 so that the RAW image data can be developed according to the set development condition.

The developed image data is temporarily stored in the first data storage unit 216 under the control of the CPU 210, and then added to the print data generation unit 220. The print data generation unit 220 generates print data based on the input image data under the control of the CPU 210 (step S118). The generated print data is stored in the first data storage unit 216.

Afterwards, the CPU 210 determines whether or not the print mode is set to “automatic print mode” (step S19).

An “automatic print mode” refers to a mode in which received image data is automatically printed without a print directive from a user. The print server 200 can select the “automatic print mode” or “manual print mode” in which data is printed with a print directive from a user.

The print mode is set using the display unit 230 and the operation unit 228. That is, a print mode selection screen is displayed on the display unit 230, and a user can selects the “automatically print mode” or the “manual print mode” using the operation unit 228. The information about the selected print mode is recorded in, for example, EEPROM, etc.

When the CPU 210 determines that the print mode is not set to “automatic print mode”, the presence/absence of a print directive from a user is determined (step S120). A print directive is assumed to be input from the operation unit 228, and the CPU 210 determines the presence/absence of a print directive from the operation unit 228.

If it is determined that the print mode is set to “automatic print mode”, or that a print directive is input under the “manual print mode”, the CPU 210 determines whether or not communication has been established with the printer 300 (step S121). If it is determined that communication has been established with the printer 300, the print data stored in the first data storage unit 216 is transmitted to the printer 300 (step S122), and the set number of image prints of the set print size are printed on the printer 300.

Afterwards, the CPU 210 determines whether or not the printing process has been completed (step S123). If it determines that the printing process has been completed, it moves the image data stored in the first data storage unit 216 to the second data storage unit 218 (step S124). Then, after the data is completely moved, it is determined whether or not the camera has been turned off (step S125). If it has not been turned off, control is returned to step S10, and the above-mentioned processes are repeated.

As described above, when there is a print directive in the image data received from the digital camera 10, the print server 200 generates print data based on the received image data. After the printing process, the data is stored in the second data storage unit 218. On the other hand, the image data received from the digital camera 10 does not include a print directive, the print data generating process is not performed, but the data is recorded as is in the second data storage unit 218.

Thus, by recording the image data in the second data storage unit 218 regardless of the presence/absence of a print directive, image data can be effectively prevented from being lost or destroyed. Furthermore, original image data can be stored in the second data storage unit 218 so that although an image is to be corrected after printing, the quality of the image can be protected against degradation.

Since the print server 200 is provided with the RAW image data development unit 222, although RAW image data is transmitted from the digital camera 10, the data can be printed without fail. Since RAW image data is processed in a different development system depending on the type of camera, the RAW image data development unit 222 is assumed to be able to develop RAW image data from various cameras.

In the present embodiment, when a print directive is included in image data, print data is generated from the image data, and the generated print data is output to a printer, and then the image data is moved from the first data storage unit 216 to the second data storage unit 218. However, the timing of moving the image data to the second data storage unit 218 is not limited to this application. For example, after generating print data, the data can be moved from the first data storage unit 216 to the second data storage unit 218, or print data can be generated and simultaneously moved to the second data storage unit 218 (the image data is added from the first data storage unit 216 to the print data generation unit 220, and simultaneously moved to the second data storage unit 218).

In the above-mentioned embodiment, when a print condition is not set in the image data received from the digital camera 10, an image is printed according to a predetermined print condition stored in the development/print condition storage unit 224. However, when no print condition is set in the image data received from the digital camera 10, a user can manually set a print condition using the display unit 230 and the operation unit 228.

Simultaneously, when no development condition is set in the RAW image data received from the digital camera 10, a user can manually set a development condition using the display unit 230 and the operation unit 228.

In addition, a predetermined print condition and development condition to be stored in the development/print condition storage unit 224 can be optionally set by a user.

When image data is printed, the print condition of the printed image data can be stored in the development/print condition storage unit 224 as a predetermined print condition. In this case, each time the printing process is performed, a new print condition is stored in the development/print condition storage unit 224. Therefore, when there is no print condition set in received image data, the data is printed with the same print condition as the last printed image data.

Similarly, when RAW image data is developed, the development condition of the developed RAW image data can be stored as a predetermined development condition in the development/print condition storage unit 224. Also in this case, each time a developing process is performed, a new development condition is stored in the development/print condition storage unit 224. Therefore, when a development condition is not set in the received RAW image data, the data is developed with the same development condition as the last developed RAW image data.

In the present embodiment, a print server and a printer are separately provided, but they can be incorporated into one unit by incorporating the function of the print server into the printer.

Also in the present embodiment, the communication between the printer 300 and the print server 200 is performed using a wireless communication device, but a cable communication device can also be used. Similarly, a cable communication device can be used between the digital camera 10 and the print server 200.

Furthermore, according to the present embodiment, a communication device is incorporated into each of the digital camera 10, the print server 200, and the printer 300. However, an external communication device can be used.

As described above, a communication device is not specifically limited. For example, a radio LAN system, a Bluetooth system, an infrared system, etc. can be applied. Therefore, communication can be established using a public line, and the digital camera 10 can be configured by a mobile telephone with a camera.

The type of camera is also not limited. As in the above-mentioned embodiment, the present invention can be applied to a compact type digital camera, and also to a single-lens reflex camera. In addition, as described above, it can be applied to a mobile telephone with a camera, and to a PDA, PC, etc. with a camera.

The present embodiment is illustrated for the case where image data captured by a digital camera is transmitted to a print server, but a destination external equipment unit of image data is not limited to this example, but image data can be transmitted to a PC, a printer, a digital camera, etc.

What is claimed is:

1. An image pickup apparatus which obtains image data from an image pickup device at a capture directive, performs predetermined signal processing on the image data, and records the image data on a storage medium, comprising:
a communication device which communicates data with external equipment;
a time count device which counts elapsed time from last capture; and
a communication control device which transmits the image data through the communication device to the external equipment when the elapsed time counted by the time count device exceeds predetermined time.

2. An image pickup apparatus which obtains image data from an image pickup device at a capture directive, performs predetermined signal processing on the image data, and records the image data on a storage medium, comprising:
a communication device which communicates data with external equipment;
a contact detection device which detects contact of a finger with a release button directing capture;
a time count device which counts elapsed time from last detection of the contact detection device; and
a communication control device which transmits the image data through the communication device to the external equipment when the elapsed time counted by the time count device exceeds predetermined time.

3. The image pickup apparatus according to claim 1, further comprising:
an image analysis device which analyzes image data, and detects the number of persons taken in a captured image;
a number-of-prints setting device which sets the number of persons detected by the image analysis device to the number of prints, wherein information about the number of prints set by the number-of-prints setting device is added and resultant image data is transmitted to external equipment.

4. The image pickup apparatus according to claim 2, further comprising:
an image analysis device which analyzes image data, and detects the number of persons taken in a captured image;
a number-of-prints setting device which sets the number of persons detected by the image analysis device to the number of prints, wherein
information about the number of prints set by the number-of-prints setting device is added and resultant image data is transmitted to external equipment.

5. The image pickup apparatus according to claim 3, further comprising:
a display device which displays the number of persons detected by the image analysis device;
an amendment device which amends the number displayed on the display device, wherein
the number-of-prints setting device sets the number amended by the amendment device to the number of prints.

6. The image pickup apparatus according to claim 4, further comprising:
a display device which displays the number of persons detected by the image analysis device;
an amendment device which amends the number displayed on the display device, wherein
the number-of-prints setting device sets the number amended by the amendment device to the number of prints.

7. The image pickup apparatus according to claim 1, further comprising
a print size setting device which sets a print size of image data, wherein
information about a print size set by the print size setting device is added and resultant image data is transmitted to external equipment.

8. The image pickup apparatus according to claim 2, further comprising
a print size setting device which sets a print size of image data, wherein
information about a print size set by the print size setting device is added and resultant image data is transmitted to external equipment.

9. The image pickup apparatus according to claim 6, further comprising
a print size setting device which sets a print size of image data, wherein
information about a print size set by the print size setting device is added and resultant image data is transmitted to external equipment.

10. The image pickup apparatus according to claim 1, further comprising
a development condition setting device which sets a development condition of RAW image data, wherein
information about a development condition set by the development condition setting device is added and resultant RAW image data is transmitted to external equipment.

11. The image pickup apparatus according to claim 2, further comprising
a development condition setting device which sets a development condition of RAW image data, wherein
information about a development condition set by the development condition setting device is added and resultant RAW image data is transmitted to external equipment.

12. The image pickup apparatus according to claim 6, further comprising
a development condition setting device which sets a development condition of RAW image data, wherein
information about a development condition set by the development condition setting device is added and resultant RAW image data is transmitted to external equipment.

13. The image pickup apparatus according to claim 8, further comprising
a development condition setting device which sets a development condition of RAW image data, wherein
information about a development condition set by the development condition setting device is added and resultant RAW image data is transmitted to external equipment.

14. The image pickup apparatus according to claim 1, further comprising:
a matching device which checks whether or not image data transmitted through the communication device matches image data received by the external equipment; and
a deletion device which deletes image data transmitted through the communication device from the storage medium when the image data transmitted through the communication device matches the image data received by the external equipment as a result of matching by the matching device.

15. The image pickup apparatus according to claim 2, further comprising:
a matching device which checks whether or not image data transmitted through the communication device matches image data received by the external equipment; and
a deletion device which deletes image data transmitted through the communication device from the storage medium when the image data transmitted through the communication device matches the image data received by the external equipment as a result of matching by the matching device.

16. The image pickup apparatus according to claim 6, further comprising:
a matching device which checks whether or not image data transmitted through the communication device matches image data received by the external equipment; and
a deletion device which deletes image data transmitted through the communication device from the storage medium when the image data transmitted through the communication device matches the image data received by the external equipment as a result of matching by the matching device.

17. The image pickup apparatus according to claim 8, further comprising:
a matching device which checks whether or not image data transmitted through the communication device matches image data received by the external equipment; and
a deletion device which deletes image data transmitted through the communication device from the storage medium when the image data transmitted through the communication device matches the image data received by the external equipment as a result of matching by the matching device.

18. The image pickup apparatus according to claim 12, further comprising:
a matching device which checks whether or not image data transmitted through the communication device matches image data received by the external equipment; and
a deletion device which deletes image data transmitted through the communication device from the storage medium when the image data transmitted through the communication device matches the image data received by the external equipment as a result of matching by the matching device.
